(19) United States
(12) Patent Application Publication
(10) Pub. No.: US 2015/0276412 A1
(43) Pub. Date: Oct. 1, 2015

(54) Global Positioning System Routing Based On Altering Arrival Time

(71) Applicant: LENOVO ENTERPRISE SOLUTIONS (SINGAPORE) PTE. LTD, SINGAPORE (SG)

(72) Inventors: Gary D. Cudak, Wake Forest, NC (US); Christopher J. Hardee, Raleigh, NC (US); Adam Roberts, Moncure, NC (US); Adrian X. Rodriguez, Durham, NC (US)

(73) Assignee: International Business Machines Corporation, Armonk, NY (US)

(21) Appl. No.: 14/230,030

(22) Filed: Mar. 31, 2014

(51) Int. Cl. G01C 21/10

(52) U.S. Cl. CPC G01C 21/10

(57) ABSTRACT

GPS routing that: (i) determines a desired arrival time, based on expected completion time of an in-vehicle activity and a destination, for a trip being made by a vehicle; and (ii) performs GPS routing to determine a first route so that a first arrival time corresponding to the first route will be substantially the same as the desired arrival time. When the vehicle travels the first route to reach the destination the in-vehicle will generally be completed at about the same time the trip is completed. In many cases, the first route will not correspond to any of the following: (i) a shortest distance route, (ii) a least fuel consumptive route; and/or (iii) a quickest route.

### BACKGROUND

The present invention relates generally to the field of routing with reference to global positioning system data (herein referred to as “GPS routing”), and more particularly to dynamic changes in GPS routing.

For purposes of this document, GPS is defined as any system that can determine the geographic location of a vehicle (or set of vehicles) travelling on land, in the air, or on water, on an ongoing basis using a computer (which may or may not be located, or wholly located, in the vehicle) without requiring any sort of wired connection to the moving vehicle. Typically, currently conventional GPS systems include: (i) a receiver in or on the vehicle that receives signals from certain satellites in orbit above the Earth; and (ii) machine logic (for example, software) to calculate a geographic position based upon the identity and/or timing of the received satellite signals. However, “GPS” as used herein: (i) does not necessarily imply the use of satellites; (ii) does not mean that position can be determined over the entire Earth, or even over a significant proportion of the earth; (iii) does not necessarily imply any maximum latency; and/or (iv) does not necessarily imply any minimum resolution for geographic location. For purposes of this document, a “geographic location” may be a location in the air (for example, the location of a passenger jet). “Terrestrial location” will herein be used to denote geographic locations limited to the earth's surface (including locations covered by water). “Road location” will herein be used to mean locations on roads for land vehicles (including bridges) that are at, or at least near, the earth's surface.

As used in this document, “GPS routing” refers to actions performed by a computer system that determines (or at least recommends) routes for vehicles based, at least in part on GPS data: (i) from the vehicle being routed; and/or (ii) other vehicles that are travelling through geographic locations. GPS routing may be done in a vehicle being controlled by a human user (which human user may, or may not, be present in the vehicle) or in “an autonomous vehicle” that is being controlled by machine logic. GPS routing is typically done so that the vehicle arrives at the earliest time or by the shortest route.

### SUMMARY

According to an aspect of the present invention, there is a method, computer program product and/or system that performs the following steps (not necessarily in the following order): (i) determining a desired arrival time, based on expected completion time of an in-vehicle activity and a destination, for a trip being made by a vehicle; and (ii) performing GPS routing to determine a first route so that a first arrival time corresponding to the first route will be substantially the same as the desired arrival time. At least the performance of GPS routing is performed by a computer.

### BRIEF DESCRIPTION OF THE DRAWINGS

FIG. 1 is a schematic view of a first embodiment of a system according to the present invention;

FIG. 2 is a flowchart showing a process performed, at least in part, by the first system; and

FIG. 3 is a schematic view of a software portion of the first embodiment system.

### DETAILED DESCRIPTION

In some embodiments of the present invention, GPS routing determines a trip-related aspect (for example, a target arrival time or a recommended routing) for an ongoing trip, and then changes this trip-related aspect based on trip-related data received during the ongoing trip. Examples of trip-related data include: (i) completion of a task (such as a conference call); and (ii) media content (such as content from a radio program or show).

This Detailed Description section is divided into the following sub-sections: (i) The Hardware and Software Environment; (ii) Example Embodiment; (iii) Further Comments and/or Embodiments; and (iv) Definitions.

### I. The Hardware and Software Environment

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

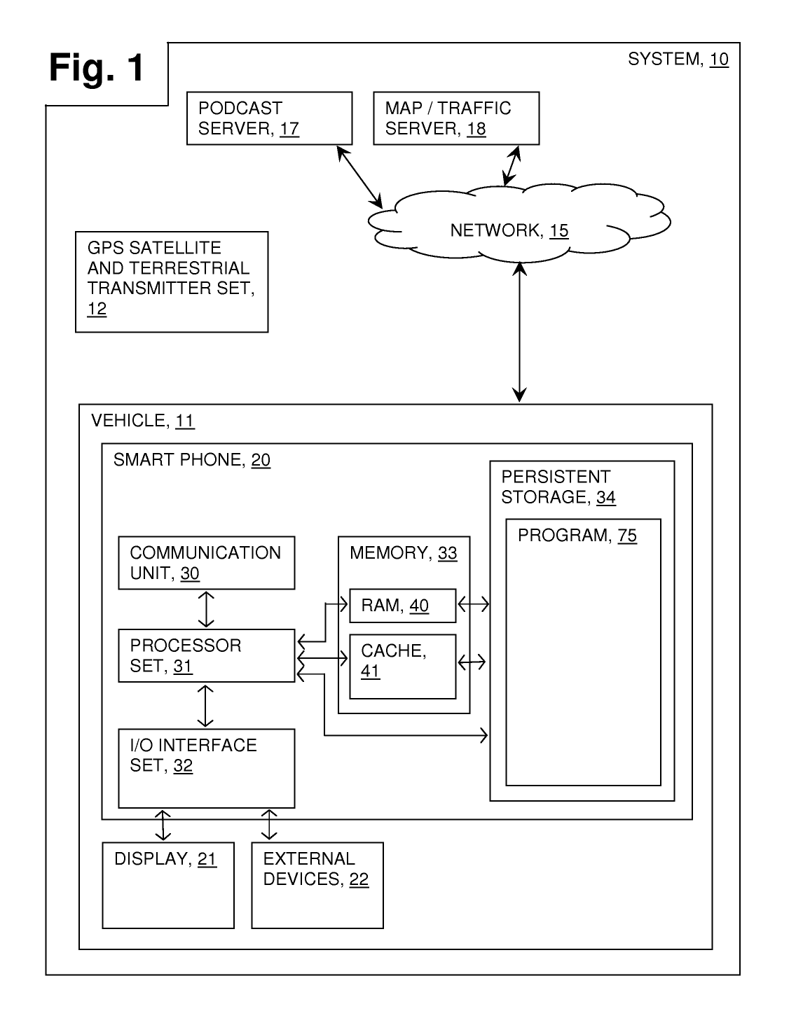

An embodiment of a possible hardware and software environment for software and/or methods according to the present invention will now be described in detail with reference to the Figures. FIG. 1 is a functional block diagram illustrating various portions of system 10, including: vehicle 11; GPS satellite and terrestrial transmitter set 12; podcast server 17; map/traffic server 18; communication network 15; smart phone 20; communication unit 30; processor(s) set 31; input/output (I/O) interface set 32; memory device 33; persistent storage device 34; display device 21; external device set 22; random access memory (RAM) devices 40; cache memory device 44; and program 75.

In this embodiment, vehicle 11 is a driverless (that is computer controlled) passenger automobile designed for travel over established roads on land. Alternatively, vehicle 11 could take other forms, such as a human controlled vehicle, a human powered vehicle, an aircraft or a watercraft. In this embodiment, the global positioning system (GPS) includes both satellite and terrestrial transmitters, and it does not cover the entire Earth, but only North America. In this embodiment, podcast server 17 serves audio for various “podcasts” (that is internet audio programs made by private individuals, often with a low degree of formality). In this embodiment, map/traffic server 18 serves map and traffic information on an ongoing basis to facilitate GPS routing (and associated scheduling) by remote, and generally wireless) client devices.

Smart phone 20 is a computer (see definition, below, in the definitions sub-section of this Detailed Description section), and it has hardware and software for receiving GPS signals from transmitter set 12. In this embodiment, smart phone 20 (that is, the in-vehicle device) also has sufficient data, access to data and/or processing power to use the received signals to calculate a position of the device. Alternatively, the positional calculation may be done by a device other than the in-vehicle device, such as a remote position calculating server. While the in-vehicle device may or may not have a lot of computational or processing power and ability, in at least most embodiments, the in-vehicle device will at least be able to: (i) receive the wireless signals of transmitter set 12; and (ii) either calculate a global position based on the received signals, or transmit the signals (or data corresponding to the received signals) wirelessly over a communication network so that a position can be calculated remotely from the vehicle.

Program 75 is a collection of machine readable instructions and/or data that is used to create, manage and control certain software functions that will be discussed in detail, below, in the Example Embodiment sub-section of this Detailed Description section.

Smart phone 20 is capable of communicating with other computer sub-systems via network 15. Network 15 can be, for example, a local area network (LAN), a wide area network (WAN) such as the Internet, or a combination of the two, and can include wired, wireless, or fiber optic connections (although there should be at least one wireless link to smart phone 20 so that smart phone 20 can travel freely and untethered in vehicle 11). In general, network 15 can be any combination of connections and protocols that will support communications between server and client sub-systems.

Smart phone 20 is shown as a block diagram with many double arrows. These double arrows (no separate reference numerals) represent a communications fabric, which provides communications between various components of smart phone 20. This communications fabric can be implemented with any architecture designed for passing data and/or control information between processors (such as microprocessors, communications and network processors, etc.), system memory, peripheral devices, and any other hardware components within a system. For example, the communications fabric can be implemented, at least in part, with one or more buses.

Memory 33 and persistent storage 34 are computer-readable storage media. In general, memory 33 can include any suitable volatile or non-volatile computer-readable storage media. It is further noted that, now and/or in the near future: (i) external device(s) 22 may be able to supply, some or all, memory for smart phone 20; and/or (ii) devices external to smart phone 20 may be able to provide memory for smart phone 20.

Program 75 is stored in persistent storage 34 for access and/or execution by one or more of the respective computer processors 31, usually through one or more memories of memory 33. Persistent storage 34: (i) is at least more persistent than a signal in transit; (ii) stores the program (including its soft logic and/or data), on a tangible medium (such as magnetic or optical domains); and (iii) is substantially less persistent than permanent storage. Alternatively, data storage may be more persistent and/or permanent than the type of storage provided by persistent storage 34.

Program 75 may include both machine readable and performable instructions and/or substantive data (that is, the type of data stored in a database). In this particular embodiment, persistent storage 34 includes a magnetic hard disk drive. To name some possible variations, persistent storage 34 may include a solid state hard drive, a semiconductor storage device, read-only memory (ROM), erasable programmable read-only memory (EPROM), flash memory, or any other computer-readable storage media that is capable of storing program instructions or digital information.

The media used by persistent storage 34 may also be removable. For example, a removable hard drive may be used for persistent storage 34. Other examples include optical and magnetic disks, thumb drives, and smart cards that are inserted into a drive for transfer onto another computer-readable storage medium that is also part of persistent storage 34.

Communications unit 30, in these examples, provides for communications with other data processing systems or devices external to smart phone 20. In these examples, communications unit 30 includes one or more network interface cards. Communications unit 30 may provide communications through the use of either or both physical and wireless communications links. Any software modules discussed herein may be downloaded to a persistent storage device (such as persistent storage device 34) through a communications unit (such as communications unit 30).

I/O interface set 32 allows for input and output of data with other devices that may be connected locally in data communication with smart phone 20. For example, I/O interface set 32 provides a connection to external device set (that is, smart phone peripheral set) 22. External device set 22 may include devices such as a keyboard, keypad, a touch screen, and/or some other suitable input device. External device set 22 can also include portable computer-readable storage media such as, for example, thumb drives, portable optical or magnetic disks, and memory cards. Software and data used to practice embodiments of the present invention, for example, program 75, can be stored on such portable computer-readable storage media. In these embodiments the relevant software may (or may not) be loaded, in whole or in part, onto persistent storage device 34 via I/O interface set 32. I/O interface set 32 also connects in data communication with display device 21.

In this embodiment, display device 21 is a smart phone touchscreen display and provides a mechanism to display data to a vehicle occupant (that is, driver or passenger).

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

### II. Example Embodiment

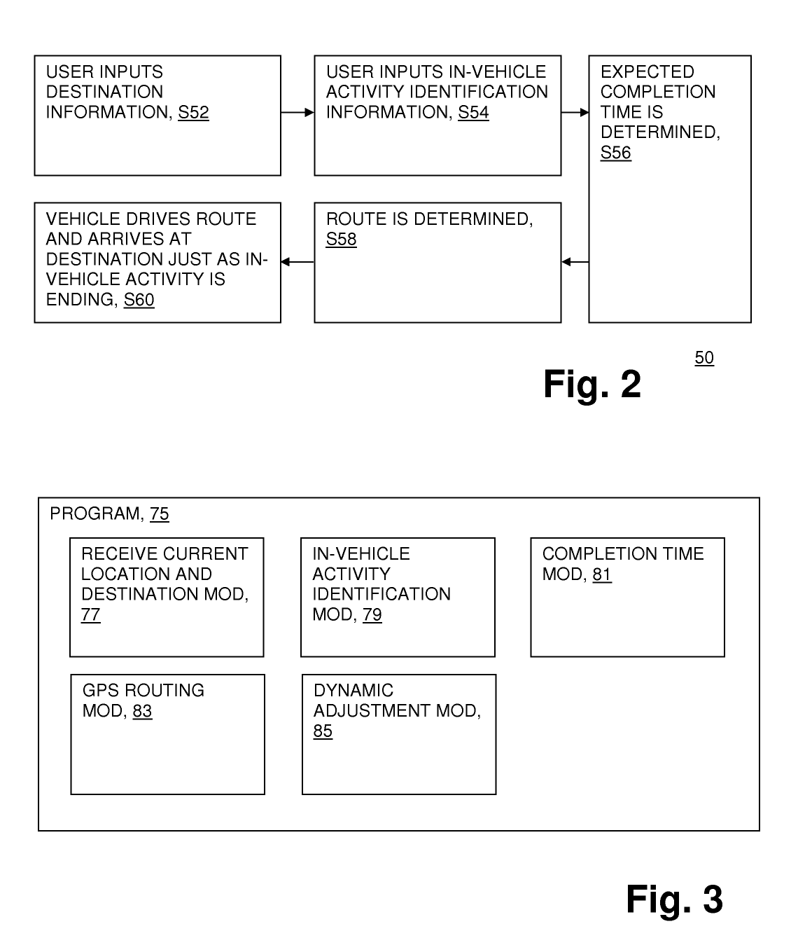

FIG. 2 shows flowchart 50 showing a method according to the present invention. FIG. 3 shows program 75 for performing at least some of the method steps of flowchart 50. This method and associated software will now be discussed, over the course of the following paragraphs, with extensive reference to FIG. 2 (for the method step blocks) and FIG. 3 (for the software blocks).

Processing begins at step S52, where receive current location and destination module (“mod”) 77: (i) calculates the current (or starting) position of smart phone 20 and driverless vehicle 11 based on wireless signals received from transmitter set 12 (see FIG. 1); and (ii) receives user input specifying the destination of a trip that vehicle 11 is going to make. Alternatively, the destination information could be pre-programmed as software (for example, part of the software, not shown, that drives the driverless vehicle), or received remotely through network 15 (for example, a remote driver or monitor remotely specifies a destination and sends it to mod 77).

Processing proceeds to step S54, where in-vehicle activity mod 79 receives user input indicating an identity of an in-vehicle activity (see definition, below in the Definitions sub-section of this Detailed Description section) that is to be completed during the trip specified at step S52. In this example of flow chart 50, a passenger of the driverless vehicle, using touchscreen display device 21 (see FIG. 1), specifies episode 67b of the Able Baker Podcast, a comedy podcast hosted by two up and coming internet comedians by the names of Able and Baker. Passenger further indicates that she plans to start the podcast when the voyage begins.

Alternatively, the user may simply enter a completion time corresponding to expected completion of a planned, or in-progress, in-vehicle activity. As a further alternative, the in-vehicle activity could come from an external source. For example, if students were going on a field trip on a bus, the in-vehicle activity might be an interactive learning program that is chosen and administered by machine logic (for example, software) from a remote learning center server computer over network 15. In this example, the completion time would be an estimated completion time because interactive program durations are determined in part by the actions of the student using the program.

Processing proceeds to step S56 where expected completion time mod 81 of the in-vehicle activity is determined based on identification of the in-vehicle activity determined at step S54. In this example of flow chart 50, mod 81 queries podcast server 17 (see FIG. 1) to determine the duration of the Able Baker Podcast. The duration is 35 minutes, which is greater than the amount of time required to complete the specified trip by the quickest route.

Processing proceeds to step S58, where GPS routing mod 83 determines a route for the trip which will arrive at the destination at the time as close as possible to the time when the passenger's planned presentation of the Able Baker Podcast will end. This route is not: (i) the shortest distance route, (ii) the least fuel consumptive route; and/or (iii) the quickest route. GPS routing mod 83 bases its route on: (i) the starting location; (ii) maps and traffic information queried and received from maps/traffic server 18 over network 15 (see FIG. 1); (iii) the destination; and (iv) the completion time of the in-vehicle activity. In some embodiments, mod 83 may be programmed to drive as quickly as possible to a location near the destination and then simply drive around the block multiple ties until completion time is reached. In other embodiments, mod 83 will avoid, or at least minimize driving in loops that are created merely to consume time.

Processing proceeds to step S60 where vehicle 11 drives the route determined at step S58 and arrives at its destination at substantially the same time the Able Baker Podcast is ending. In this context, “substantially” means that a reasonable person would consider the trip and podcast to have ended at about the same time for practical purposes. The passenger is glad that his podcast ended at just the same time his 35 minute trip ended. Alternatively, dynamic adjustment mod 85 may make adjustments to the route, the driving speed and/or the in-vehicle activity in order to preserve the synchronicity between the end of the trip and the completion of the in-vehicle activity. For example, if, at some point during the trip, vehicle position (as tracked by GPS) makes it look like the vehicle will get to the destination before the end of the Able Baker Podcast, then one or more of the following corrective measures may be taken by dynamic adjustment mod 85: (i) the route may be lengthened by choosing a different set of roads; (ii) freeway speed may be reduced from 65 miles per hour to 60 miles per hour; and/or (iii) the playing speed of the Able Baker Podcast may be sped up so that the podcast reaches completion at an earlier point in time.

### III. Further Comments and/or Embodiments

Some embodiments of the present invention: (i) use machine logic to perform “GPS routing” so that the end of a trip (herein called “arrival”) will be close in time to finishing some other activity (for example, a conference call, a radio program, a song or a show); (ii) set a route so that arrival is close in time to completion of an activity being engaged in by an occupant of the vehicle making the trip (for example, a driver); (iii) set a route so that arrival is close in time to completion of an activity being engaged in by an occupant of the vehicle making the trip (for example, a driver); (iv) set a route so that arrival is purposely delayed to be close in time to completion of an activity being engaged in by someone other than an occupant of the vehicle (for example, restaurant provides time estimate of when take out order will be ready); and/or (v) set a route so that arrival is close in time to completion of an activity that has been scheduled according to data available on a communication network (for example, a radio program schedule available over the internet, a computer based appointment schedule made available over the internet).

One embodiment of a method according to the present invention includes the following steps (not necessarily in the following order): (i) driver is en route to a destination; (ii) driver begins playing or listening to media or joins a conference call; (iii) system compares the remaining time expected for the trip and the expected completion time for the task; (iv) if the completion time for the task is longer than the remaining time, but still within a certain threshold of adding time to the trip, increase the level of efficiency for the planning by reducing speed or changing route to match the end of the task; (v) recalculate and alter the efficiency level as needed for the duration of the trip; and (vi) if the task ends early, the standard speed/efficiency level can be set.

Some embodiments of the present invention may include one, or more, of the following features, characteristics and/or advantages: (i) allows the task to be completed before arrival; (ii) increases the efficiency of the travel to save energy costs; (iii) this can be done for multiple passengers as well; (iv) possibly reroute to multiple destinations based on when tasks for the individual passengers will be done and when they need to arrive; (v) an autonomous car could incorporate this and alter speed or route like the GPS could; (vi) in the event that the task is performed with time to spare, the system might also suggest an alternate task that could be completed within the window of travel time; (vii) in the event that a slower route is needed due to a current task extending past the travel time, the car may negotiate with another vehicle (which needs to travel faster) to take a more congested road in exchange for allowing that vehicle to take the less congested route or toll/speed lane; and/or (viii) the negotiation mentioned in the previous item could include exchanging credits.

Some embodiments of the present invention may include one, or more, of the following features, characteristics and/or advantages: (i) complete a desired program while in the vehicle (that is, prior to arriving at a destination); (ii) increasing the trip time by choosing a lesser route that takes longer to travel, but a route where arrival time corresponds to the end time of the desired program; (iii) notification of a desire to complete a program; (iv) determination of remaining length of a program; and/or (v) selecting a route which best matches the end time of the program (within constraints of other known variables).

### IV. Definitions

Present invention: should not be taken as an absolute indication that the subject matter described by the term “present invention” is covered by either the claims as they are filed, or by the claims that may eventually issue after patent prosecution; while the term “present invention” is used to help the reader to get a general feel for which disclosures herein that are believed as maybe being new, this understanding, as indicated by use of the term “present invention,” is tentative and provisional and subject to change over the course of patent prosecution as relevant information is developed and as the claims are potentially amended.

Embodiment: see definition of “present invention” above—similar cautions apply to the term “embodiment.”

and/or: inclusive or; for example, A, B “and/or” C means that at least one of A or B or C is true and applicable.

Module/Sub-Module: any set of hardware, firmware and/or software that operatively works to do some kind of function, without regard to whether the module is: (i) in a single local proximity; (ii) distributed over a wide area; (iii) in a single proximity within a larger piece of software code; (iv) located within a single piece of software code; (v) located in a single storage device, memory or medium; (vi) mechanically connected; (vii) electrically connected; and/or (viii) connected in data communication.

Computer: any device with significant data processing and/or machine readable instruction reading capabilities including, but not limited to: desktop computers, mainframe computers, laptop computers, field-programmable gate array (fpga) based devices, smart phones, personal digital assistants (PDAs), body-mounted or inserted computers, embedded device style computers, application-specific integrated circuit (ASIC) based devices.

GPS routing: may be land, sea and/or air travel routing; GPS routing (and “routes” determined by GPS routing will generally include the land, sea and/or air path travelled by the vehicle, and may further include adjustment of other travel parameter(s) affecting the scheduled arrival at destination time (for example, adjustment of vehicle speed, scheduled stops, etc.).

In-vehicle activity: includes, but is not limited to, the following: a scheduled teleconference or telephone call being conducted, at least in part, in the vehicle, a broadcast television or radio program being received in the vehicle, a prerecorded television or radio program being watched or listened to in the vehicle, other prerecorded content such as an audio lecture or music album being presented in the vehicle; “in-vehicle activity,” as that term is hereby defined, does not include mere passage of time that occurs before an arbitrary predetermined arrival time, passage of time to wait for traffic conditions to be suitable, passage of time to wait for weather conditions to be suitable, passage of time to wait for a scheduled appointment (for example, waiting for a scheduled takeout food pickup time) or scheduled event (for example, a sporting event).

What is claimed is:

1. A method comprising:
determining a desired arrival time, based on expected completion time of an in-vehicle activity and a destination, for a trip being made by a vehicle; and
performing GPS routing to determine a first route so that a first arrival time corresponding to the first route will be substantially the same as the desired arrival time;
wherein:
at least the performance of GPS routing is performed by a computer.

2. The method of claim 1 further comprising:
taking, by the vehicle, the first route to reach the destination.

3. The method of claim 1 wherein the first route does not correspond to any of the following: (i) a shortest distance route, (ii) a least fuel consumptive route; and/or (iii) a quickest route.

4. The method of claim 1 further comprising:
receiving, through user input to a computer, the destination.

5. The method of claim 1 further comprising:
receiving, through user input to a computer, the expected completion time of the in-vehicle activity.

6. The method of claim 1 further comprising:
receiving, through user input to a computer, an identification of the in-vehicle activity; and
determining, automatically and substantially without human intervention, the expected completion time of the in-vehicle activity by making queries over a communication network.

7. The method of claim 1 wherein the in-vehicle activity is an activity by one of the following: a driver of the vehicle, or a passenger of the vehicle.

8. The method of claim 1 wherein the vehicle is at least one of the following types:
aircraft, watercraft or land vehicle.

9. The method of claim 1 wherein the vehicle is a land vehicle suitable for travel only over established roads.

10. A computer program product comprising a computer readable storage medium having stored thereon:
first program instructions programmed to determine a desired arrival time, based on expected completion time of an in-vehicle activity and a destination, for a trip being made by a vehicle; and
second program instructions programmed to perform GPS routing to determine a first route so that a first arrival time corresponding to the first route will be substantially the same as the desired arrival time.

11. The product of claim 10 wherein the storage medium further has written thereon:
third program instructions programmed to take, by the vehicle, the first route to reach the destination.

12. The product of claim 10 wherein the first route does not correspond to any of the following: (i) a shortest distance route, (ii) a least fuel consumptive route; and/or (iii) a quickest route.

13. The product of claim 10 wherein the storage medium further has written thereon:
third program instructions programmed to receive, through user input to a computer, the destination.

14. The product of claim 10 further wherein the storage medium further has written thereon:
third program instructions programmed to receive, through user input to a computer, the expected completion time of the in-vehicle activity.

15. The product of claim 10 wherein the storage medium further has written thereon:
third program instructions programmed to receive, through user input to a computer, an identification of the in-vehicle activity;
fourth program instructions programmed to determine, automatically and substantially without human intervention, the expected completion time of the in-vehicle activity by making queries over a communication network.

16. The product of claim 10 wherein the in-vehicle activity is an activity by one of the following: a driver of the vehicle, or a passenger of the vehicle.

17. The product of claim 10 wherein the vehicle is at least one of the following types: aircraft, watercraft or land vehicle.

18. The product of claim 10 wherein the vehicle is a land vehicle suitable for travel only over established roads.

19. A computer system comprising:
a processor(s) set; and
a computer readable storage medium;
wherein:
the processor set is structured, located, connected and/or programmed to run program instructions stored on the computer readable storage medium; and
the program instructions include:
first program instructions programmed to determine a desired arrival time, based on expected completion time of an in-vehicle activity and a destination, for a trip being made by a vehicle; and
second program instructions programmed to perform GPS routing to determine a first route so that a first arrival time corresponding to the first route will be substantially the same as the desired arrival time.

20. The system of claim 19 wherein the storage medium further has written thereon:
third program instructions programmed to take, by the vehicle, the first route to reach the destination.
